(19) United States
(12) Patent Application Publication
(10) Pub. No.: US 2016/0180401 A1
(43) Pub. Date: Jun. 23, 2016

(54) METHOD AND SYSTEM FOR CONTEXTUAL ADVERTISING

(71) Applicant: ShareThis, Inc., Palo Alto, CA (US)

(72) Inventors: Souvik RAY, Fremont, CA (US); Fadi OBEID, Mountain View, CA (US); Akash VARSHNEY, Fremont, CA (US); Prasanta BEHERA, Cupertino, CA (US); Nanda KISHORE, Los Altos, CA (US)

(73) Assignee: SHARETHIS, INC., Palo Alto, CA (US)

(21) Appl. No.: 14/581,895

(22) Filed: Dec. 23, 2014

(51) Int. Cl. G06Q 30/02; G06Q 50/00; G06F 17/30

(52) U.S. Cl. CPC G06Q 30/0269; G06F 17/30867; G06Q 30/0242; G06Q 50/01

(57) ABSTRACT

A method and system target an audience segment in real-time based on social activities of users. A set of keywords associated with a brand and a set of keywords associated with a first plurality of users is compared. When there is match between the two sets of keywords, a seed audience segment that includes a subset of the first plurality of users is generated. User profiles of users from the seed audience segment based on features are generated. Subsequently, model files of features, feature threshold scores, and an overall feature threshold score corresponding to the user profiles are calculated and provided to a real-time bidding (RTB) server. When the RTB server receives a bid request for a cookie, the RTB server computes a model score corresponding to the cookie based on the model files and accepts the bid request if the model score is above the overall feature threshold score.

### BACKGROUND

1. Field

Systems and methods consistent with the exemplary embodiments relate to online advertising. More particularly, systems and methods consistent with the exemplary embodiments relate to real-time targeting of audience for online contextual advertising.

2. Description of the Related Art

Over the years, the use of the Internet has risen. Recently, the Internet as a platform for commercial activities has gained popularity. One of the major reasons of increased use of the Internet is its easy accessibility by way of improved infrastructure and a wide range of devices to access it.

With the growth of the Internet, the online advertising sector has seen a major boom. Nowadays, online advertising is one of the major media of advertising products and services for various companies. Online advertising involves publishers and advertisers. A publisher is an entity that displays advertisements (ads) on its website. An advertiser is an entity that provides ads to be displayed on the publisher's website. Online advertising includes electronic mails (emails), search engine marketing, display advertising, and mobile advertising. Display advertising uses text, logos, pictures, videos, and the like to advertise on a website. Display advertisers often track a user's activity on the Internet to target ads to the most potential user. This is referred to as ‘targeted advertising’. Behavioral targeting and contextual advertising are types of targeted advertising.

Behavioral targeting includes monitoring and tracking user activities such as sites visited, content viewed, duration of time spent on a particular website, and the like by way of cookies. A cookie is a piece of data that is sent from a website and stored in a user's web browser operating in a device. The cookie records and tracks the web browser activities, such as clicks, websites visited, time of the day, and the like, thus tracking the online behavior of the user. Advertisers provide ads to the users based on their online behavioral pattern.

Contextual advertising involves displaying ads to users based on the content of the website. A contextual advertising system parses the content on the website and identifies a set of keywords associated therewith. When users visit a website, advertisers provide ads to the users based on the identified set of keywords. For example, a user reading an article related to mobile phones on a technology website is provided with ads by various mobile phone companies on the technology website. The online advertisers may also combine behavioral targeting and contextual advertising to identify a potential audience segment.

An online advertising architecture further includes ad exchanges and real-time bidding (RTB) servers. Ad exchanges, such as ADECN™, Doubleclick™ by Google™ and RightMedia™ are online platforms that facilitate bidded buying and selling of advertisements from multiple ad networks. RTB servers facilitate real-time bidding through which ad inventory is bought or sold via programmatic auction. Advertisers have advertising campaigns running on various publisher websites. Ads are served as impressions on these publisher websites to the target audience segment. With real time bidding, ad buyers bid based on impressions, and if the bid is successfully won, the ad is instantaneously displayed on the publisher website.

The success of an advertising campaign is determined by way of a click-through rate (CTR). The CTR represents a ratio of the number of clicks to the number of impressions for an ad and hence, measures the success of an ad campaign. A high CTR implies that more impressions are converted in to clicks, i.e., the advertising campaign is a success. However, for an impression to get clicked or converted it is important that the ad is directed to the correct audience. The correct audience segment is identified by tracking activities of users in the computer network over a period of time and understanding their interests. In recent times, with increasing and varying user activities, it is difficult to keep a track of the user activities and define a specific intent for a particular user over a period of time. For example, when a user is interested in buying a pair of headphones, she may read reviews of various available models on the internet. If the headphone ads are displayed to her at a later time, there is a possibility that she might have purchased the desired headphones from an online store or a brick and mortar store between the time of her reading the reviews and display of the relevant ad. In other words, the ad impression is wasted because the user is no longer interested in the advertised product. Thus, there is a need to identify user intents and interests in real-time.

Further, the online behavior of users is not limited to regular page-views or landing on web pages through search engines. A page-view refers to the number of times a web page is viewed by a user. Users visit a number of social networking sites such as Facebook™, LinkedIn™, Twitter™, Quora™, and so on, and share content of their interest on such sites regularly. Thus, such social activity of users is required to be utilized to determine user interests and intent in real-time and consequently target relevant ads to such an audience segment. Also, the social activities of users need to be used to expand audience segments and achieve high CTRs.

In light of the aforementioned drawbacks of the traditional methods of contextual advertising, it is desirable to provide a method and system that expand audience segments in real-time based on social activities of users and perform real-time audience targeting for contextual advertising.

### SUMMARY

An aspect of an exemplary embodiment provides a method and system for real-time audience targeting for contextual advertising in a computer network.

An aspect of an exemplary embodiment provides a method and system for real-time expansion of an audience segment based on social sharing activities of users.

An exemplary embodiment provides a system for real-time audience targeting for contextual advertising. The system includes a memory storage device and a processor. The memory storage device stores a first plurality of keywords associated with a brand, a first plurality of user identifications (IDs) associated with a first event, a second plurality of keywords associated with the first plurality of user IDs and the first event, and a third plurality of user IDs associated with a second event. An audience segment is served a plurality of advertisements corresponding to the brand. The processor is connected to the memory storage device. The processor receives the first plurality of user IDs from the memory storage device. The first plurality of user IDs corresponds to a first plurality of users and the first event includes a sharing activity performed by the first plurality of users. The processor receives the second plurality of keywords from the memory storage device and compares the first and second plurality of keywords. The processor generates a second plurality of user IDs when a first set of the first plurality of keywords matches a first set of the second plurality of keywords. The second plurality of user IDs corresponds to a second plurality of users and the second plurality of user IDs is a set of the first plurality of user IDs. The processor generates a set of user profiles corresponding to the second plurality of user IDs based on a plurality of sets of features corresponding to the second plurality of user IDs. The memory storage device stores the plurality of sets of features. The processor generates a set of model files corresponding to a set of features of the plurality of sets of features based on the set of user profiles. A first model file of the set of model files includes a first subset of the set of features and a corresponding first subset of a set of feature scores. The processor calculates a set of feature threshold values corresponding to the plurality of sets of features based on the corresponding first subset of the set of feature scores, a time of day, a day of week, and a social activity. The processor calculates a set of feature weights corresponding to the plurality of sets of features based on a logistic regression model and calculates a threshold value based on the set of feature threshold values and the set of feature weights. The memory storage device stores the plurality of sets of features, the set of feature threshold values, the set of feature weights, and the threshold value. A real-time bidding (RTB) server is connected to the processor and the memory storage device. The RTB server receives the third plurality of user IDs. The third plurality of user IDs correspond to a third plurality of users and the second event includes a sharing activity performed by the third plurality of users. The processor calculates a set of model scores corresponding to the third plurality of user IDs based on the plurality of sets of features, the set of feature threshold values, and the set of feature weights. The processor compares each model score of the set of model scores with the threshold value. The processor generates a fourth plurality of user IDs by combining a first set of the third plurality of user IDs with the second plurality of user IDs when each model score of a first subset of the set of model scores is at least one of greater than and equal to the threshold value. The first subset of the set of model scores corresponds to the first set of the third plurality of user IDs. The processor stores the fourth plurality of user IDs in the memory storage device.

Another exemplary embodiment provides a method for real-time audience targeting for contextual advertising. An audience segment is served a plurality of advertisements corresponding to a brand. A first plurality of keywords associated with the brand is received. A first plurality of user IDs associated with a first event is received. The first plurality of user IDs corresponds to a first plurality of users and the first event includes a sharing activity performed by the first plurality of users. A second plurality of keywords associated with the first event is received. The first and second pluralities of keywords are compared. A second plurality of user IDs is generated when a first set of the first plurality of keywords matches a first set of the second plurality of keywords. The second plurality of user IDs corresponds to a second plurality of users. The second plurality of user IDs is a set of the first plurality of user IDs. A set of user profiles corresponding to the second plurality of user IDs is generated based on a plurality of sets of features corresponding to the second plurality of user IDs. A set of model files corresponding to a set of features of the plurality of sets of features is generated based on the set of user profiles. A first model file of the set of model files includes a first subset of the set of features and a corresponding first subset of a set of feature scores. A set of feature threshold values corresponding to the plurality of sets of features is calculated based on the corresponding first subset of the set of feature scores, a time of day, a day of week, and a social activity. A set of feature weights corresponding to the plurality of sets of features is calculated based on a logistic regression model. A threshold value is calculated based on the set of feature threshold values and the set of feature weights. A third plurality of user IDs associated with a second event is received. The third plurality of user IDs corresponds to a third plurality of users and the second event includes a sharing activity performed by the third plurality of users. A set of model scores corresponding to the third plurality of user IDs is calculated based on the plurality of sets of features, the set of feature threshold values, and the set of feature weights. Each model score of the set of model scores is compared with the threshold value. A fourth plurality of user IDs is generated by combining a first set of the third plurality of user IDs with the second plurality of user IDs when each model score of a first subset of the set of model scores is at least one of greater than and equal to the threshold value. The first subset of the set of model scores corresponds to the first set of the third plurality of user IDs.

Yet another exemplary embodiment provides a computer program product comprising a non-transitory machine-readable medium that stores a program. The program is executed by a machine for expanding an audience segment for contextual advertising. The audience segment is served a plurality of advertisements corresponding to a brand. A first plurality of keywords associated with the brand is received. A first plurality of user IDs associated with a first event is received. The first plurality of user IDs corresponds to a first plurality of users and the first event includes a sharing activity performed by the first plurality of users. A second plurality of keywords associated with the first event is received. The first and second pluralities of keywords are compared. A second plurality of user IDs is generated when a first set of the first plurality of keywords matches a first set of the second plurality of keywords. The second plurality of user IDs corresponds to a second plurality of users. The second plurality of user IDs is a set of the first plurality of user IDs. A set of user profiles corresponding to the second plurality of user IDs is generated based on a plurality of sets of features corresponding to the second plurality of user IDs. A set of model files corresponding to a set of features of the plurality of sets of features is generated based on the set of user profiles. A first model file of the set of model files includes a first subset of the set of features and a corresponding first subset of a set of feature scores. A set of feature threshold values corresponding to the plurality of sets of features is calculated based on the corresponding first subset of the set of feature scores, a time of day, a day of week, and a social activity. A set of feature weights corresponding to the plurality of sets of features is calculated based on a logistic regression model. A threshold value is calculated based on the set of feature threshold values and the set of feature weights. A third plurality of user IDs associated with a second event is received. The third plurality of user IDs corresponds to a third plurality of users and the second event includes a sharing activity performed by the third plurality of users. A set of model scores corresponding to the third plurality of user IDs is calculated based on the plurality of sets of features, the set of feature threshold values, and the set of feature weights. Each model score of the set of model scores is compared with the threshold value. A fourth plurality of user IDs is generated by combining a first set of the third plurality of user IDs with the second plurality of user IDs when each model score of a first subset of the set of model scores is at least one of greater than and equal to the threshold value. The first subset of the set of model scores corresponds to the first set of the third plurality of user IDs.

### BRIEF DESCRIPTION OF DRAWINGS

The features of the exemplary embodiments, which are believed to be novel, are set forth with particularity in the appended claims. Exemplary embodiments will hereinafter be described in conjunction with the appended drawings provided to illustrate and not to limit the scope of the claims, wherein like designations denote like elements, and in which:

FIG. 1 is a schematic block diagram illustrating a system for real-time audience targeting for contextual advertising, in accordance with an exemplary embodiment;

FIG. 2 is a schematic block diagram illustrating generation of a seed audience segment, in accordance with an exemplary embodiment;

FIG. 3 is a schematic block diagram illustrating generation of user profiles of users in the seed audience segment, in accordance with an exemplary embodiment;

FIG. 4 is a schematic block diagram illustrating generation of a set of feature weights, a set of feature threshold scores, and a model scoring equation, in accordance with an exemplary embodiment;

FIG. 5 is a schematic block diagram illustrating a computer system, in accordance with an exemplary embodiment; and

FIG. 6 is a flow chart illustrating a method for real-time targeting of audience for contextual advertising, in accordance with an exemplary embodiment.

### DETAILED DESCRIPTION OF THE EXEMPLARY EMBODIMENTS

As used in the specification and claims, the singular forms “a”, “an” and “the” include plural references unless the context clearly dictates otherwise. For example, the term “an article” may include a plurality of articles unless the context clearly dictates otherwise.

Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the exemplary embodiments.

There may be additional components described in the foregoing application that are not depicted on one of the described drawings. In the event such a component is described, but not depicted in a drawing, the absence of such a drawing should not be considered as an omission of such design from the specification.

Before describing the exemplary embodiments in detail, it should be observed that the exemplary embodiments can utilize computer-implemented method for real-time targeting of audience for online advertising. Accordingly, the system components and the method steps have been represented where appropriate by conventional symbols in the drawings, showing only specific details that are pertinent for an understanding of the exemplary embodiments so as not to obscure the disclosure with details that will be readily apparent to those with ordinary skill in the art having the benefit of the description herein. While the specification concludes with the claims defining the features of the exemplary embodiments that are regarded as novel, it is believed that the exemplary embodiments will be better understood from a consideration of the following description in conjunction with the drawings, in which like reference numerals are carried forward.

Detailed exemplary embodiments are disclosed herein; however, it is to be understood that the disclosed exemplary embodiments are merely exemplary and can be embodied in various forms. Therefore, specific structural and functional details disclosed herein are not to be interpreted as limiting, but merely as a basis for the claims and as a representative basis for teaching one skilled in the art to variously employ the present exemplary embodiments in virtually any appropriately detailed structure. Further, the terms and phrases used herein are not intended to be limiting but rather to provide an understandable description of the exemplary embodiments.

### Definition of Terms

Advertisement campaign (Ad campaign): An advertisement campaign is a sequence of advertisement messages based on a product or a service that are delivered to one or more users through the Internet and World Wide Web. Examples of advertisement campaigns may include, but are not limited to, contextual advertisements on web pages, banner advertisements, rich media advertisements, social network advertisements, online classified advertisements, and advertisements via e-mail marketing, including e-mail spam and/or the like.

Event: An event is an action performed by a user on various websites. The event is also referred to as a user activity. Examples of events include, but are not limited to, sharing through a tracking component such as a widget, a button, a social optimizing pixel, a retargeting pixel, a hypertext, a HyperText Markup Language (HTML) tag, and a link, viewing a web page, clicking a web link, visiting a web page or searching for a keyword. The actions could be either social, where the user shares a Universal Resource Link (URL) to social networks or clicks back to the URL from a social network, or non-social such as a regular page view or landing on the URL through search engines. A page-view refers to the number of times a web page is viewed by a user.

Advertisement data (Ad data): Advertisement data may include, but are not limited to, creatives, impressions, advertisement inventory, channels, timelines, budgets, and other information, including historical information relating to use and distribution of advertisements. The advertisement data may also include advertisement campaign descriptors. The advertisement data may also include an identifier for the user e.g., a cookie, the web page content category, time, price paid, advertisement message shown, and resulting user actions or behavior, or some other type of advertisement campaign and heuristic logs. The advertisement data may also include business statistical data, which may describe dynamic and/or static marketing objectives, or may describe the operation of the advertising server. Finally, the advertisement data in context of the present exemplary embodiments is not limited to the examples cited herein. Any other data related to online advertisements may be used appropriately and the examples cited herein do not restrict the scope of the exemplary embodiments in any way.

Advertisement space (Ad space): An ad space is a space on a web page reserved for displaying the advertisement campaigns. Generally, the ad space is located at the top, bottom, right, or left columns of the web page. The location depends on the size of the advertisement campaign to be displayed, the layout of the page, and the advertising space available on the page.

Advertisement impression (Ad impression): An ad impression (hereinafter referred to as “impression”) refers to the number of times an advertisement is viewed. For example, if an advertisement campaign is viewed by 1,000 users over the course of a day, it is said that the advertisement campaign had 1,000 impressions, as each user viewed goods or services advertised therein. The impression is counted in different ways depending upon format of the ad space situated on the web page, as well as the number of times the web page is shown where the advertisement appears. A number of impressions corresponding to the advertisement campaign is tracked by a tracking component to measure the success of the advertisement campaign.

Audience Segment: An audience segment corresponds to a class or group of the audience. An advertisement campaign finely tuned to an audience segment offers better results, a higher response rate, and a higher conversion rate. Targeting the advertisements to an appropriate audience segment not only enhances the visits but also increases the conversion rates many times. Conversion rate (also known as conversion marketing) is a ratio of the number of transactions performed to the total number of users visiting the website.

Advertisement Conversion (Ad conversion): Advertisement conversion happens when the user performs an action on an advertiser's website after viewing an advertisement. The advertisement conversion may include, but is not limited to, clickthrough, viewthrough, browsethrough, game conversion, and/or the like.

Publisher: A publisher is a group, organization, company, or an individual responsible for originating a production of or maintaining a website. A publisher's revenue comprises advertising revenue paid for by the advertising servers in exchange for placements of their advertisement campaigns on the publisher's website. Advertising servers are servers connected to database servers that store advertisements to be displayed on to websites maintained by the publishers. For example, a site such as Facebook is a publisher and generates revenues by displaying advertisements from various advertisers such as Amazon, Walmart, and the like.

Time of day: The hours of the day during which events occur at a device. The hour of the day is measured according to the local time zone of the device.

Day of the week: The days of the week during which events occur at the device.

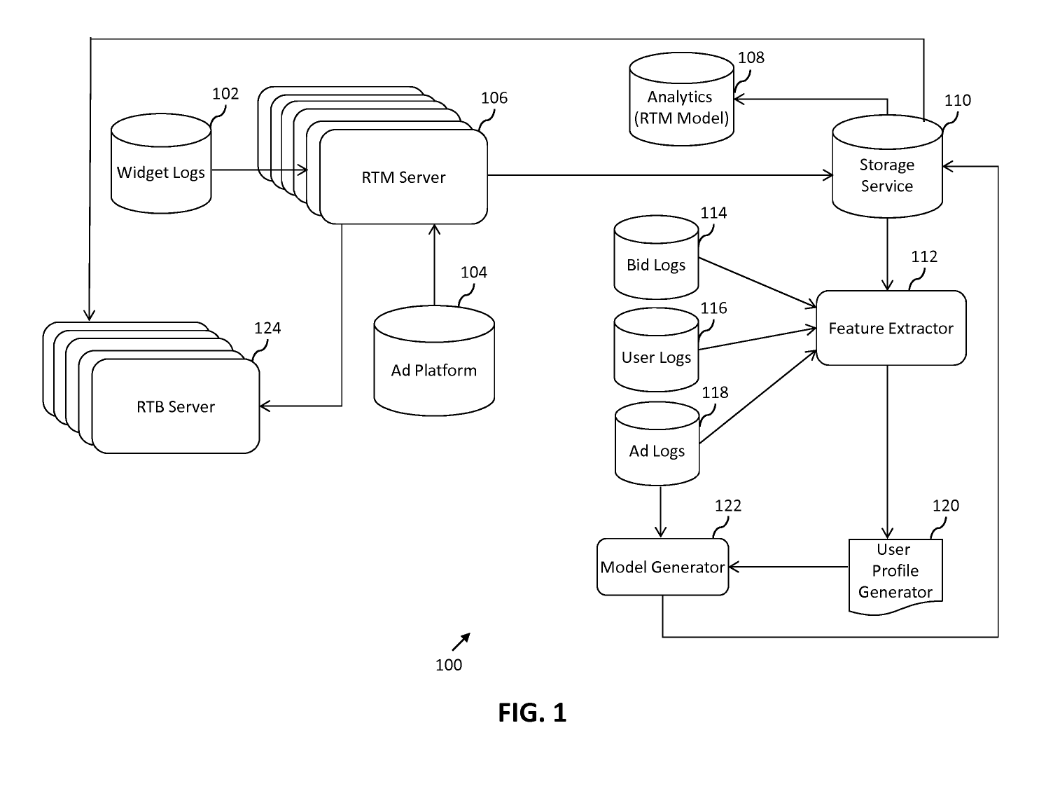

Referring now to FIG. 1, a schematic block diagram of a system 100 for real-time targeting of audience for online advertising, in accordance with an exemplary embodiment is shown. The system 100 is a demand side supply (DSP) platform that bids for the online advertisements on behalf of advertisers and manages their bids. The system 100 includes widget logs 102, an Ad Platform 104, a real-time marketing (RTM) server 106, an analytics repository (RTM model) 108, a storage device 110, a feature extractor 112, bid logs 114, user logs 116, ad logs 118, a user profile generator 120, a model generator 122, and a real-time bidding (RTB) server 124. The widget logs 102 may be stored in a single storage device or a cluster of storage devices. The storage device 110 may be a network storage device or may be a virtual storage such as cloud storage. The RTB server 124, the feature extractor 112, the user profile generator 120, and the model generator 122 form a cluster of machines. The feature extractor 112, the user profile generator 120, and the model generator 122 may be implemented in a single processor or in multiple processors or as separate devices, such as servers. The cluster of machines further includes an advertising (ad) server (not shown). The ad server generates the bid logs 114, the user logs 116, and the ad logs 118. The analytics repository 108 is used for reporting and analyzing the performance of the system 100. The exemplary embodiments for real-time targeting of audience are implemented by the system 100 and are described herein.

In an example, an advertising campaign is initiated by a car manufacturing company. A brand of the car manufacturing company is identified by a set of keywords. For example, an automobile brand like Toyota™ is associated with a set of keywords such as autos, Toyota Camry, Lexus, Scion, airbag, Toyota Vitz, car dealerships, Toyota RAV, Toyota Land Cruiser, Toyota Prado, car insurance, Prius, auto repair, Innova, and so on. The Ad Platform 104 stores the set of keywords associated with the advertising campaign.

To advertise the brand Toyota™ to the most relevant audience segment and to expand the audience segment, a seed audience segment that includes users with interest in automobiles is identified. A user is identified by way of a cookie. However, the user may be identified by way of a persistent device signature as well. For example, a user A reads an article related to automobiles and shares a URL to the article on a social networking website, such as Facebook™ by way of the ShareThis™ widget. The ShareThis™ widget is a web-application written in Java-script that may be embedded in third-party sites through which users can share page content to a number of social channels, including Gmail™, Twitter™, Whatsapp™, Facebook™, Google™, Instagram™, Picasa™, Skype™, StumbleUpon™, DropBox™, and the like. User B, who is a Facebook friend of the user A, receives the URL in his news feed, and visits the web page of the shared article. When the user B visits the shared web page and also shares the URL, a set of keywords associated with the shared URL are recorded in the widget logs 102. Similarly, sets of keywords associated with various URLs are recorded in the widget logs 102 for various events, such as page-view events and click-back events (social as well as non-social) performed by various users. The sets of keywords may be captured by the widget logs 102 by way of a high throughput distributed messaging system known as real-time Kafka system. Kafka may be implemented as a cluster of servers including one or more servers. The sets of keywords are captured in a keyword in context (KWIC) format. It should be noted that Kafka and the generation of n-grams in KWIC is well known in the art and further description of them is avoided so as not to obfuscate the present specification. The captured sets of keywords represent the users' intent and interest.

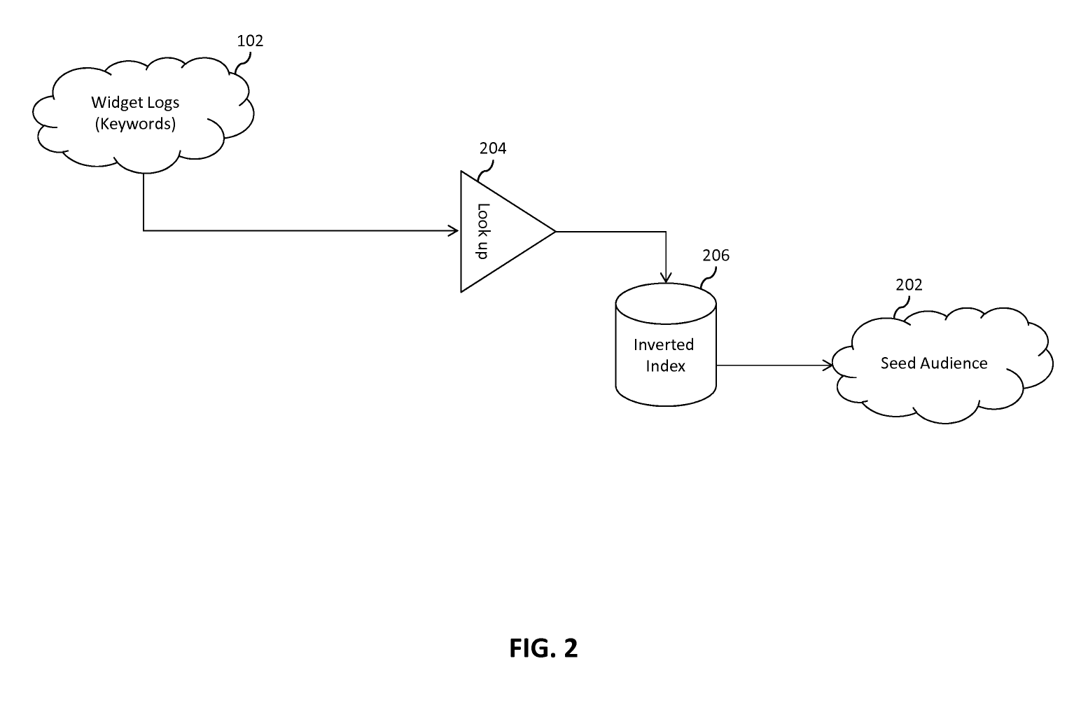

Referring now to FIG. 2, a schematic block diagram illustrating generation of a seed audience segment 202, in accordance with an exemplary embodiment is shown. A lookup performer 204, preferably implemented by using the RTM server 106, receives sets of keywords associated with the user A's and B's activity from the widget logs 102 and the set of keywords associated with the brand Toyota from the Ad Platform 104 and determines whether there is a match between the two sets of keywords. The RTM server 106 may be a single server or a cluster of servers. The RTM server 106 includes a real-time inverted index 206 stored at a memory thereof, that allows fast text based searching. The sets of keywords associated with the user A's and B's activity and the set of keywords associated with the brand Toyota are stored in the real-time inverted index 206 based on a combination of keyword similarity and a native score. The real-time inverted index format may be a Lucene™ index format that is well known in the art. For example, Scion is a word that co-occurs with Toyota™. A list of words with their corresponding co-occurring words is stored in the real-time inverted index 206. The native score is an index functionality that is calculated using an information retrieval model called vector space and is well known in the art. When a user identified by a cookie performs a social activity such as sharing a URL, clicking a shared URL, or lands on a page by searching, a set of keywords associated with the social activity is matched with the set of keywords associated with a brand by the lookup performer 204. For example, the set of keywords associated with the URL of the article on cars includes cars, airbag, car insurance, auto repair, and autos. This set of keywords includes a few of the keywords from the set of keywords associated with the brand Toyota™. Thus, there is a match between the two sets of keywords and the cookies associated with the users A and B are categorized as a part of a seed audience segment 202 for ad targeting. Information such as user identification (ID), the user search key strings, the URL where the event (sharing) occurred, the time of occurrence of the event, and the matching ad group of a user in the seed audience segment 202 is stored in the storage device 110. The storage device 110 may be a network storage device or may be a virtual storage such as cloud storage. Such keywords are captured in near-real time based on trending topics. For example, during Oscars, “Oscar top runners” and for iPhone release, “iPhone 6”, “iPhone 6 plus” are keywords associated with trending topics that are captured.

A user may reset his/her cookies that results in the cookie being deleted. Moreover, certain websites and browsers prevent setting of cookies. This phenomenon of cookies being deleted or expired is referred to as cookie churn. Due to cookie churn, a seed audience segment size is limited and sufficient impressions cannot be served. Therefore, a contextual feature extraction-based method is used in which certain important features like page-view category, user demographics, and other social user segments (e.g. finance, lifestyle, personal-travel based segments) are used to expand the audience size. The selection of these features is based on click-through rate (CTR) optimization. A logistic regression-based method uses click logs to generate a prediction model, which outputs these relevant features.

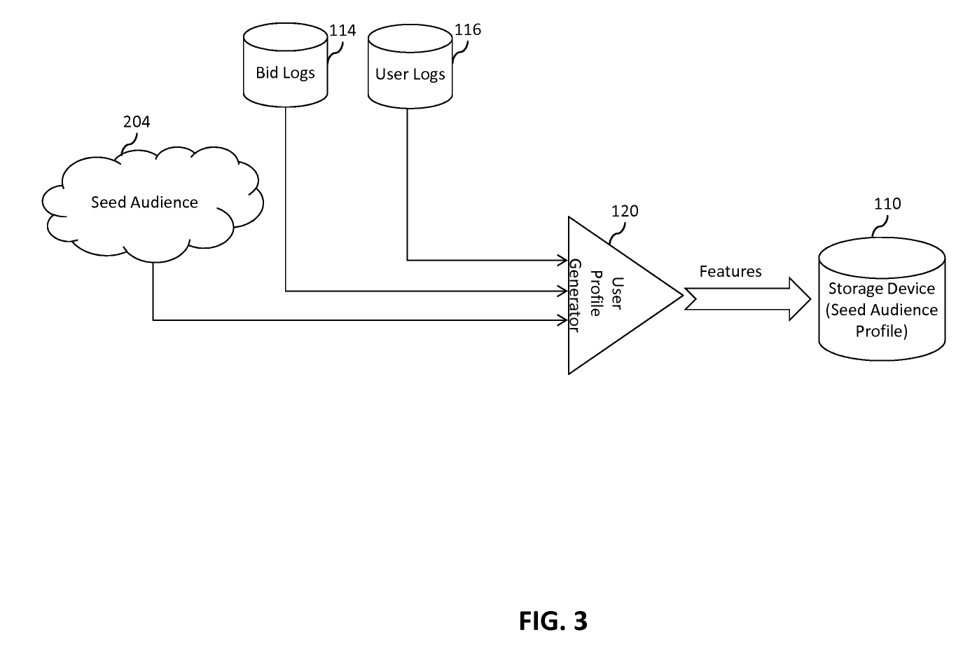

Referring now to FIG. 3, a schematic block diagram illustrating generation of user profiles of users in the seed audience segment 206, in accordance with an exemplary embodiment is shown. The bid logs 114 record the impressions served to users through the RTB server 124. The bid logs 114 records information such as bid ID (e.g. b0550000008e5a94ac18823d6f275121), bidding price, user-agent (e.g. Mozilla/5.0 (Windows NT 5.1), IP addresses of users, time of impression (e.g. 2014/11/28 10:00:00 UCT) and the ad log 118 record information such as ad-specific content such as ad slot ID, creative ID, and ad group ID (e.g. 100000859). The ad slot ID represents a location of an impression on the web page and the creative ID is an ad creative of the advertiser for which a bid is placed at the RTB server 124. A bid is a price offer for the ad creative. The ad group ID corresponds to an ad group that includes one or more ads that share a common set of keywords. The user logs 116 record user-specific information, such as demographics and user segments. The information from the bid logs 114, the user logs 116, and the ad logs 118 also represents features associated with the user IDs. In the aforementioned example, for the user A, the user logs 116 store demographics information such as gender: male, age group: 21-24, location: USA and user segment as automobiles indicating that the user A belongs to an audience segment that includes men of the age group 21-24 years, located in the USA, and interested in automobiles.

The user profile generator 120 receives inputs from the bid logs 114, the user logs 116, and the ad logs 118 and generates a profile for each user in the seed audience segment 202 using aggregated feature values. The aggregation of feature values is done over a window of days. The number of days is configurable. The seed audience segment 202 profiles are stored in the storage device 110. The seed audience segment 202 profiles may be stored as flat files on a distributed file system when the storage device 110 is a cluster of machines (distributed set of machines) in a cloud based system, such as the Amazon cloud. An example of a user profile record of the seed audience segment 202 (in tab-delimited Java Script Object Notation (JSON) format with 2 columns) is shown below:

CglhxVJ8P7AlzxX15M NcAg=={“categoryList”:[{“ANX”:{ }, “ADX”:{“20”:0.75, “1001”:0.26830283, “1077”:1, “998”:0.15179452}}], “sqi”:[{“176”:1}], “domains”:[{“1820”:1}], “segmentList”:[{“ANX”:{“100588”:1, “11100574”:1, “11100373”:1, “100372”:1, “100618”:1, “100366”:1, “11100641”:1}, “ADX”:{“100 588”:1, “100574”:1, “100373”:1, “100372”:1, “100618”:1, “100366”:1, “4161900”:1, “100641”:1}}], “ip”:[[“MA|Chicopee|543”]]}

The first column “CglhxVJ8P7AlzxX15MNcAg” is the cookie or the user ID. The second column “{“categoryList”:[{“ANX”:{}, “ADX”:{“20”:0.75, “1001”:0.26830283, “1077”:1, “998”:0.15179452}}], “sqi”:[{“176”:1}], “domains”:[{“1820”:1}], “segmentList”:[{“ANX”:{“100588”:1, “100574”:1, “10037 3”:1, “100372”:1, “100618”:1, “100366”:1, “100641”:1}, “ADX”:{“100588”:1, “100574”:1, “100373”:1, “100372”:1, “100618”:1, “100366”:1, “4161900”:1, “100641”:1}}], “ip”:[[“MA|Chicopee|543”]]}” represents the aggregated feature values. The aforementioned example illustrates a category list for 2 types of ad-networks, ADX and ANX. ADX refers to Double-click by Google™ ad-exchange and ANX represents Appnexus™ ad-exchange. The JSON represents key-value pairs. For example, the first entry in the category list for ADX represents “20”:0.75. In this example, “20” is the category ID and 0.75 is the corresponding score. The corresponding score represents the probability that the cookie CgIhxVJ8P7AlzxX15MNcAg is associated with the category ID 20. As described earlier, examples of category include finance, electronics, automobile, and the like. Such user profiles of the seed audience segment 202 are stored in the storage device 110.

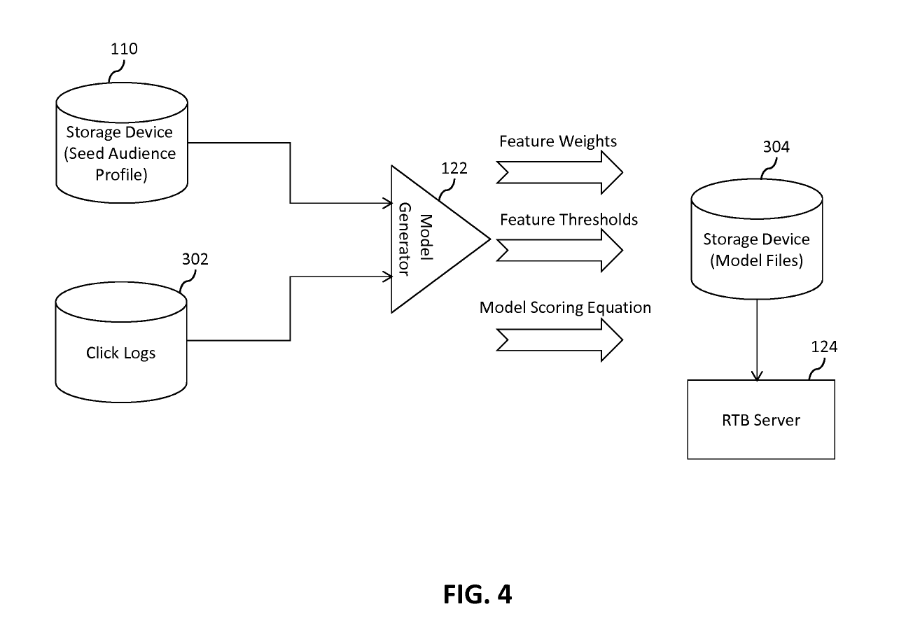

Referring now to FIG. 4, a schematic block diagram illustrating generation of a set of feature weights, a set of feature threshold scores, and a model scoring equation, in accordance with an exemplary embodiment is shown. The model generator 122 receives user profile records from the storage device 110 and for each feature in the user profile records, ranks the top N feature values using a normalized frequency count, and generates corresponding model files for each feature. The value N is configurable and is a system parameter. The feature values represent IDs of various features. For example, for a page-view category, some of the top feature values are 3, 16, 184, 105, 694, 408, 396, and 122. Each feature value is associated with a normalized frequency score (between 0 and 1) (also referred to as “feature score”). The feature score represents a ratio of the number of times a category ID is observed and the total number of times any category ID is observed. A model file for the aforementioned example of page-view category is illustrated below:

TABLE A
Model file page-view category

| Ad-network | Ad group ID | Category ID | Feature Score |
|---|---|---|---|
| ADX | 7295 | 3 | 0.026777124266618244 |
| ADX | 7295 | 16 | 0.02587672477122386 |
| ADX | 7295 | 184 | 0.018672066556028082 |
| ADX | 7295 | 105 | 0.015466310184775359 |
| ADX | 7295 | 694 | 0.014518550886177838 |
| ADX | 7295 | 408 | 0.014053611122639744 |
| ADX | 7295 | 396 | 0.01332317598095869 |
| ADX | 7295 | 122 | 0.012498164446860784 |

The model files are stored as flat files on the distributed file system in a cluster of machines such as the Amazon cloud. In this exemplary embodiment, the model files are stored in the storage device 110.

Further, the model generator 122 calculates a feature threshold score based on the feature scores and ad traffic requirements of each advertisement campaign. An ad traffic requirement of an advertisement campaign is estimated based on the daily impressions required for the advertisement campaign. To calculate an individual feature threshold score corresponding to a feature, the feature scores in the Table A are arranged in a decreasing order. The feature threshold score is calculated based on the ad traffic requirement of the advertising campaign. For example, the ad traffic requirement is 70 percent. Each feature score is multiplied by 100 and then the feature score that corresponds to a cumulative sum that is greater than or equal to 70 percent represents the feature threshold score. Following is an example of a threshold file for various ad group IDs:

| Ad group ID | Threshold Value |
|---|---|
| 100000098 | .0003494224416581208 |
| 7295 | .0002916335095500628 |
| 100000143 | .000294582556327421 |
| 5395 | .0003037828484225860 |
| 7470 | .0003185255608684173 |

The feature threshold scores are auto-adjusted to optimize for the amount of traffic and the CTR. For example, a 7-day moving average of social activity (i.e., a sum of social events) is used to predict the current social trends and the feature threshold scores are adjusted accordingly. This dynamic calculation and adjustment of the feature threshold scores is done on an hourly basis. The following general formula is used to detect the social trends. For each hour ‘k’ on a particular day, the model generator 122 determines whether the social activity lies within a range of values.

((Average−1.5*standard_deviation)<=social_activity<=(Average+1.5*standard_deviation)) (1)

If equation 1 holds true, there is no change in the impression delivery trend. Here, the average represents an average of the social activity and the standard deviation represents the amount of deviation from a mean value of the social activity. However, if the equation 1 does not hold true, then the model generator 122 multiplies the feature threshold score by a factor that is a function of the social activity, average and standard_deviation. The factor is represented by the following formulae:

(social_activity/(Average+1.5*standard_deviation)) (2)

(social_activity/(Average+1.5*standard_deviation)) (3)

When the (Average−1.5*standard_deviation) value is less than the social_activity value, the model generator 122 multiplies the feature threshold score with the equation 2. When the (Average−1.5*standard_deviation) value is greater than the social_activity value, the model generator 122 multiplies the feature threshold score with the equation 3. Similarly, the feature threshold scores are optimized for clicks of impressions as well. It is desirable to deliver maximum number of impressions, when the CTR is high. The following general formula is used to detect the CTR.

((Average−1.5*standard_deviation)<=CTR<=(Average+1.5*standard_deviation)) (4)

If the equation 4 holds true, there is no change in the impression delivery trend. However, if the equation 4 does not hold true, the model generator 122 multiplies the feature threshold score by a factor that is a function of the CTR, average and standard_deviation. The factor is represented by the following formulae:

(CTR/(Average+1.5*standard_deviation)) (5)

(CTR/(Average−1.5*standard_deviation)) (6)

When the (Average−1.5*standard_deviation) value is less than the CTR value, the model generator 122 multiplies the feature threshold score with the equation 5. When the (Average−1.5*standard_deviation) is greater than the CTR value, the model generator 122 multiplies the feature threshold score with equation 6. Similarly, the feature threshold scores are optimized for day of the week as well.

Each feature is associated with a feature weight. A weight is representative of the importance of the feature. A logistic-regression based optimization method is used to generate a feature weight. The logistic-regression method is a statistical classification model that is used to predict the effect of features on a dependent variable. For example, if the effect of feature such as category has to be predicted on the probability of a click, the probability is obtained by the logistic regression method. In the exemplary embodiment, the model generator 122 receives inputs from the click logs 302. A click log records the clicks associated with the impressions of an ad campaign besides the aforementioned user features. The model generator 122 determines the probability of the click associated with the feature category using the logistic-regression method and generates the corresponding feature weight for the feature category based on the probability of the click. Thus, the logistic-regression based optimization method is used to generate the feature weight. The model generator 122 optimizes the weight of the features using the logistic-regression based optimization method so as to achieve a high CTR. Further, the feature weights are adjusted periodically to account for shift in the CTR trends.

Once the feature threshold scores and the feature weights corresponding to the features are generated, an overall feature threshold score over all the feature threshold scores is generated by the model generator 122. The following is a general formula for calculating the overall feature threshold score:

Overall feature threshold score=feature1-wt*feature1-threshold+feature2-wt*feature2-threshold++feature n-wt*feature n-threshold, where ‘wt’ represents a weight of a corresponding feature. The feature threshold scores, the feature weights, and the overall threshold score in the form of model files are stored in the storage device 110.

To serve an impression to a cookie that is not a part of the seed audience segment 202, the RTB server 124 scores the cookie using the model files from the storage device 110. Thus, the RTB server 124 receives the model files from the storage device 110. When the RTB server 124 receives a bid request from an ad exchange (e.g. Google double-click) (not shown), an overall model score for the cookie is generated and evaluated using summation (over all features) of the product of feature value and feature weight. An overall model score is calculated by using the following equation: Overall model score=feature1-wt*feature 1-score of the cookie +. . . +feature-n-wt*feature-n-score, where ‘wt’ represents a weight of a corresponding feature. This equation is referred to as a model scoring equation. The model score is a value that ranges between 0 and 1. Further, the RTB server 124 compares the model score for the cookie with the overall feature threshold score and if the overall model score is above the overall feature threshold score, the RTB server bids and if successful, an impression is served to the cookie. The aforementioned process is repeated for each cookie resulting in an expansion of the seed audience segment 202.

It is well known in the art that the impression can be placed anywhere on the world-wide-web (WWW) network of webpages which are served by an ad-exchange. For example, an ad-network such as Double-click by Google™ sends a bid-request to the ShareThis™ RTB server when a user lands on a webpage. As described above, the RTB server 124 evaluates the cookie score using the model files and decides whether to bid for it or not. If the ShareThis™ RTB server decides to and wins the bid, the impression is served to the user.

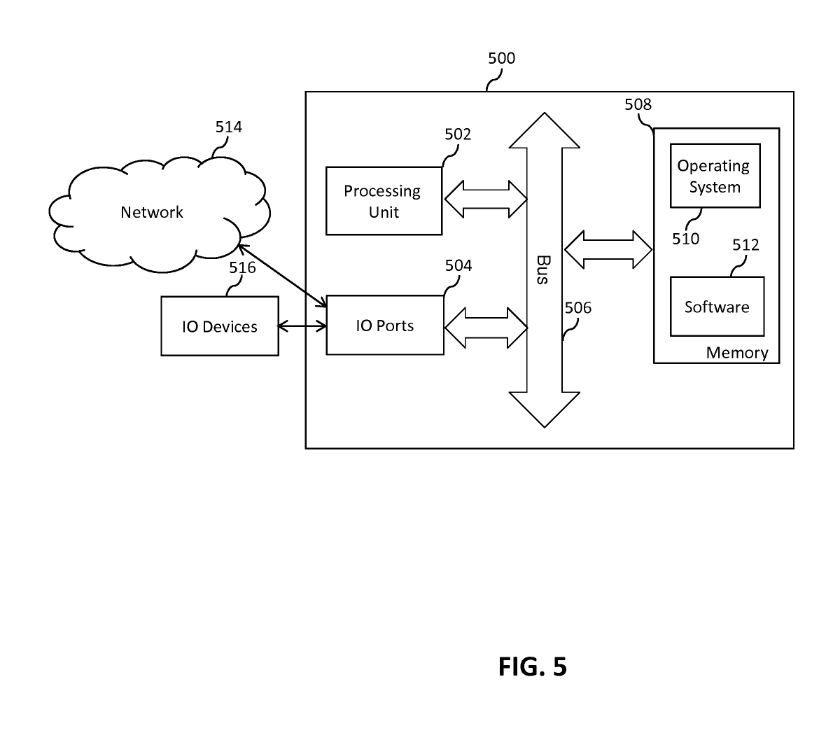

Referring now to FIG. 5, a schematic block diagram illustrating a computer system 500 for implementing various exemplary embodiments is shown. The computer system 500 may correspond to one or more of the devices such as the RTM server 106, the feature extractor 112, and the RTB server 124 in the system 100. The computer system 500 includes instructions that are required to perform the methodologies described herein. The computer system 500 may be implemented as a server machine or a client machine in a client-server computer network or a peer machine in a peer-to-peer or distributed network. The computer system 500 may be realized in the form of a personal computer, a laptop, a server, a set-top box (STB), a tablet, a Personal Digital Assistant (PDA), a cellular telephone, a web appliance, a server, a network router, a network switch, a network bridge, a video game console, or any machine capable of executing a set of computer instructions (sequential or otherwise) to be executed by the computer system 500. Further, while only a single computer system 500 is illustrated, the term ‘computer system 500’ shall also be taken to include any collection of computer systems that individually or jointly execute a set (or multiple sets) of instructions to perform any one or more of the methodologies discussed herein.

The computer system 500 includes a processor 502, an input/output (10) port 504, a system bus 506, and a memory 508. The memory 508 includes an operating system 510 and a software 512. A non-exhaustive list of examples of suitable commercially available operating systems 510 is as follows: a Windows operating system, a Netware operating system, a Macintosh operating system, a UNIX operating system, a LINUX operating system, a run time Vxworks operating system, or an appliance-based operating system, such as that implemented in handheld computers or personal data assistants (PDAs), or any other suitable operating system, including a customized operating system such as may come installed on a communications network base station, etc. The software 512 includes instructions to be executed to perform the process described here.

The memory 508 may include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 508 may incorporate electronic, magnetic, optical, and/or other types of storage media. The 10 port 504 is an interface between the computer system 500 and an external network 514, such as the Internet. The 10 port 504 may be connected to 10 devices 516. Examples of the input devices include keyboards, touch sensitive input devices, microphones, and so on to accept inputs from a user. Further, the 10 port 504 may be connected to an output device such as a display screen. The 10 port 504 and the memory 508 communicate by way of the system bus 506. The processor 502 fetches and executes the sets of instructions from the memory 508. The computer system 500 operates in a computer network that may include wired and wireless networks, such as the Internet, local area networks (LAN), metropolitan area networks (MAN), mobile networks and the like. In the exemplary embodiment of this specification, the computer network is the Internet.

The exemplary embodiments may be a program stored and provided on a non-transitory computer-readable medium. The non-transitory computer readable medium refers to a medium which does not store data for a short time such as a register, a cache memory, a memory, or the like but semi-permanently stores data and is readable by a device. In detail, the above-described applications or programs may be stored and provided on a non-transitory computer readable medium such as a CD, a DVD, a hard disk, a blue-ray disk, a universal serial bus (USB), a memory card, a ROM, or the like.

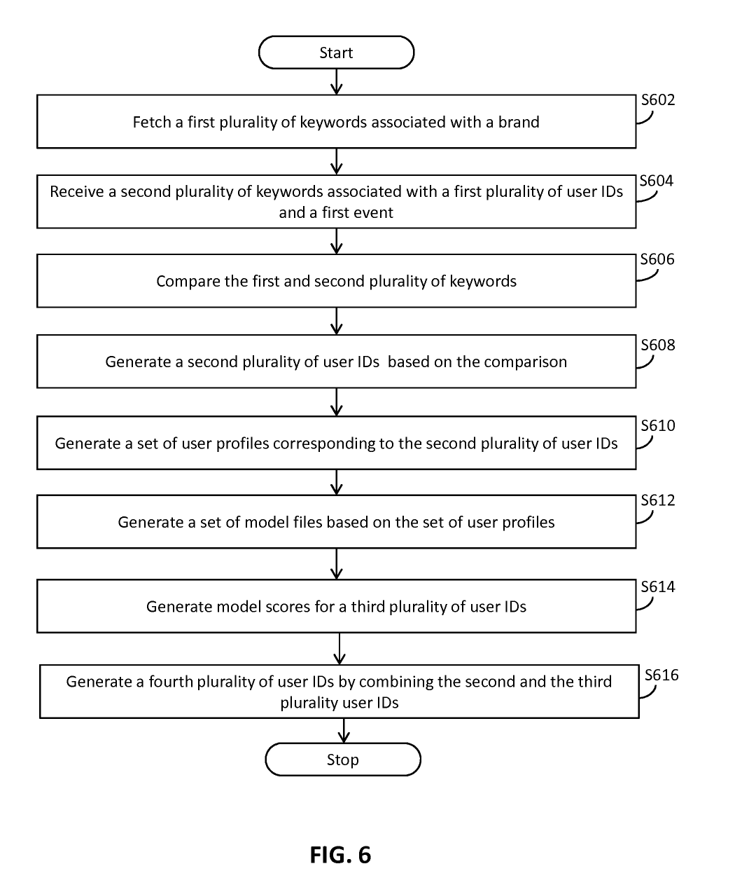

Referring now to FIG. 6, a flowchart illustrating a method of targeting an audience segment in real-time is shown. At operation S602, the RTM server 106 fetches a first plurality of keywords associated with a brand. At operation S604, the RTM server 106 fetches a second plurality of keywords associated with a first plurality of user IDs and a first event. At operation S606, the RTM server 106 compares the first and second plurality of keywords. At operation S608, the RTM server 106 generates a second plurality of user IDs based on the comparison. At operation S610, the user profile generator 120 generates a set of user profiles corresponding to the second plurality of user IDs. At operation S612, the model generator 122 generates a set of model files based on the set of user profiles. At operation S614, the RTB server 124 generates model scores for a third plurality of user IDs. At operation S616, the RTB server 124 generates a fourth plurality of user IDs by combining the second and third plurality user IDs. The details of each of these operations have already been explained in conjunction with FIGS. 1-5, and repetition is avoided so as not to obfuscate the specification.

Various exemplary embodiments offer the following advantages: The method and system provide means for real-time audience targeting for contextual advertising in a computer network. The method and system achieve real-time expansion of an audience segment based on social sharing activities of users.

In general, the various exemplary embodiments may be implemented in hardware or special purpose circuits, software, logic, or any combination thereof. For example, some aspects may be implemented in hardware, while other aspects may be implemented in firmware or software which may be executed by a processor, such as a controller, microprocessor or other computing device, although the exemplary embodiments is not limited thereto. While various aspects of the exemplary embodiments may be illustrated and described as block diagrams or flow charts, it will be understood that these blocks, apparatus, systems, techniques or methods described herein may be implemented in, as non-limiting examples, hardware, software, firmware, special purpose circuits or logic, general purpose hardware or controller or other computing devices, or some combination thereof.

Thus, the inventive concepts have been described herein with reference to a particular exemplary embodiment for a particular application. Although selected exemplary embodiments have been illustrated and described in detail, it may be understood that various substitutions and alterations are possible. Those having ordinary skill in the art and access to the present teachings may recognize additional various substitutions and alterations are also possible without departing from the spirit and scope, and as defined by the following claims.

What is claimed is:

1. An apparatus for real-time audience targeting for contextual advertising, the apparatus comprising:
at least one memory storage device configured to store a first plurality of keywords associated with a brand, a first plurality of user identifications (IDs) associated with a first event, a second plurality of keywords associated with the first plurality of user IDs and the first event, and a third plurality of user IDs associated with a second event, wherein an audience segment is served a plurality of advertisements corresponding to the brand;
at least one processor, connected to the memory storage device, wherein the processor is configured for:
receiving the first plurality of user IDs from the memory storage device, wherein the first plurality of user IDs corresponds to a first plurality of users, and wherein the first event includes a sharing activity performed by the first plurality of users;
receiving the second plurality of keywords from the memory storage device;
comparing the first and second plurality of keywords;
generating a second plurality of user IDs when a first set of the first plurality of keywords matches a first set of the second plurality of keywords, wherein the second plurality of user IDs corresponds to a second plurality of users, and wherein the second plurality of user IDs is a set of the first plurality of user IDs;
generating a set of user profiles corresponding to the second plurality of user IDs based on a plurality of sets of features corresponding to the second plurality of user IDs, wherein the memory storage device stores the plurality of sets of features;
generating a set of model files corresponding to a set of features of the plurality of sets of features based on the set of user profiles, wherein a first model file of the set of model files includes a first subset of the set of features and a corresponding first subset of a set of feature scores;
calculating a set of feature threshold values corresponding to the plurality of sets of features based on the corresponding first subset of the set of feature scores, a time of day, a day of week, and a social activity;
calculating a set of feature weights corresponding to the plurality of sets of features based on a logistic regression model; and
calculating a threshold value based on the set of feature threshold values and the set of feature weights, wherein the memory storage device stores the plurality of sets of features, the set of feature threshold values, the set of feature weights, and the threshold value; and
a real-time bidding (RTB) server, connected to the processor and the memory storage device, wherein the RTB server is configured for:
receiving the third plurality of user IDs, wherein the third plurality of user IDs corresponds to a third plurality of users, and wherein the second event includes a sharing activity performed by the third plurality of users;
calculating a set of model scores corresponding to the third plurality of user IDs based on the plurality of sets of features, the set of feature threshold values, and the set of feature weights;
comparing each model score of the set of model scores with the threshold value;
generating a fourth plurality of user IDs by combining a first set of the third plurality of user IDs with the second plurality of user IDs when each model score of a first subset of the set of model scores is at least one of greater than and equal to the threshold value, wherein the first subset of the set of model scores corresponds to the first set of the third plurality of user IDs; and
storing the fourth plurality of user IDs in the memory storage device, thereby expanding the audience segment corresponding to the second plurality of user IDs.

2. The apparatus of claim 1, wherein the first and second events further comprise at least one of a page-view activity and a landing on page activity.

3. The apparatus of claim 1, wherein the plurality of sets of features include at least one of a user segment, a demographic, and a page-view category.

4. The apparatus of claim 1, wherein a user profile of the set of user profiles includes a user ID of the second plurality of user IDs and the corresponding set of features of the plurality of sets of features.

5. The apparatus of claim 4, wherein the first subset of the set of feature scores represents an occurrence of the user profile of the set of user profiles associated with the first subset of the set of features.

6. The apparatus of claim 1, wherein the memory storage device further includes a widget log, a user log, an inverted index, a click log, and a bid log.

7. The apparatus of claim 6, wherein the widget log stores the first plurality of keywords, the user log stores the plurality of sets of features, the inverted index stores the second plurality of keywords, the click log stores a set of count of clicks associated with the plurality of sets of features, and the bid log stores a count of ad-impressions served to the first and third plurality of users.

8. The apparatus of claim 1, wherein the logistic regression model uses the click log to calculate the set of feature weights.

9. The apparatus of claim 1, wherein the RTB server multiplies a first feature weight of the set of feature weights with the corresponding first subset of the set of feature scores to obtain a first value and a second feature weight of the set of feature weights with a corresponding second subset of the set of feature scores to obtain a second value, and adds the first and second values to calculate a first model score of the set of model scores.

10. The apparatus of claim 9, wherein the processor multiplies the first feature weight with a first feature threshold value of the set of feature threshold values to obtain a third value and the second feature weight with a second feature threshold value of the set of feature threshold values to obtain a fourth value, and adds the third and fourth values to calculate the threshold value.

11. A method for real-time audience targeting for contextual advertising, wherein the audience segment is served a plurality of advertisements corresponding to a brand, the method comprising:
receiving a first plurality of keywords associated with the brand;
receiving a first plurality of user IDs associated with a first event, wherein the first plurality of user IDs corresponds to a first plurality of users, and wherein the first event includes a sharing activity performed by the first plurality of users;
receiving a second plurality of keywords associated with the first event;
comparing the first and second plurality of keywords;
generating a second plurality of user IDs when a first set of the first plurality of keywords matches a first set of the second plurality of keywords, wherein the second plurality of user IDs corresponds to a second plurality of users, and wherein the second plurality of user IDs is a set of the first plurality of user IDs;
generating a set of user profiles corresponding to the second plurality of user IDs based on a plurality of sets of features corresponding to the second plurality of user IDs;
generating a set of model files corresponding to a set of features of the plurality of sets of features based on the set of user profiles, wherein a first model file of the set of model files includes a first subset of the set of features and a corresponding first subset of a set of feature scores;
calculating a set of feature threshold values corresponding to the plurality of sets of features based on the corresponding first subset of the set of feature scores, a time of day, a day of week, and a social activity;
calculating a set of feature weights corresponding to the plurality of sets of features based on a logistic regression model;
calculating a threshold value based on the set of feature threshold values and the set of feature weights;
receiving a third plurality of user IDs associated with a second event, wherein the third plurality of user IDs corresponds to a third plurality of users, and wherein the second event includes a sharing activity performed by the third plurality of users;
calculating a set of model scores corresponding to the third plurality of user IDs based on the plurality of sets of features, the set of feature threshold values, and the set of feature weights;
comparing each model score of the set of model scores with the threshold value; and
generating a fourth plurality of user IDs by combining a first set of the third plurality of user IDs with the second plurality of user IDs when each model score of a first subset of the set of model scores is at least one of greater than and equal to the threshold value, wherein the first subset of the set of model scores corresponds to the first set of the third plurality of user IDs, thereby expanding the audience segment corresponding to the second plurality of user identifications.

12. The method of claim 11, wherein the first and second events further comprise at least one of a page-view activity and a landing on page activity.

13. The method of claim 11, wherein the plurality of sets of features includes at least one of a user segment, a demographic, and a page-view category.

14. The method of claim 11, wherein a user profile of the set of user profiles includes a user ID of the second plurality of user IDs and the corresponding set of features of the plurality of sets of features.

15. The method of claim 14, wherein the first subset of the set of feature scores represents an occurrence of the user profile of the set of user profiles associated with the first subset of the set of features.

16. The method of claim 11, wherein the logistic regression model uses a click log to calculate the set of feature weights.

17. The method of claim 11, wherein the calculating the set of model scores includes:
multiplying a first feature weight of the set of feature weights with the corresponding first subset of the set of feature scores to obtain a first value;
multiplying a second feature weight of the set of feature weights with a corresponding second subset of the set of feature scores to obtain a second value; and
adding the first and second values to obtain the first model score.

18. The method of claim 17, wherein the calculating the threshold value includes:
multiplying the first feature weight with a first feature threshold value of the set of feature threshold values to obtain a third value;
multiplying the second feature weight with a second feature threshold value of the set of feature threshold values to obtain a fourth value; and
adding the third and fourth values to obtain the threshold value.

19. A computer program product comprising a non-transitory machine-readable medium that stores a program, the program being executed by a machine for expanding an audience segment for contextual advertising, wherein the audience segment is served a plurality of advertisements corresponding to a brand, the method comprising:
receiving a first plurality of keywords associated with the brand;
receiving a first plurality of user IDs associated with a first event, wherein the first plurality of user IDs corresponds to a first plurality of users, and wherein the first event includes a sharing activity performed by the first plurality of users;
receiving a second plurality of keywords associated with the first event;
comparing the first and second plurality of keywords;
generating a second plurality of user IDs when a first set of the first plurality of keywords matches a first set of the second plurality of keywords, wherein the second plurality of user IDs corresponds to a second plurality of users, and wherein the second plurality of user IDs is a set of the first plurality of user IDs;
generating a set of user profiles corresponding to the second plurality of user IDs based on a plurality of sets of features corresponding to the second plurality of user IDs;
generating a set of model files corresponding to a set of features of the plurality of sets of features based on the set of user profiles, wherein a first model file of the set of model files includes a first subset of the set of features and a corresponding first subset of a set of feature scores;
calculating a set of feature threshold values corresponding to the plurality of sets of features based on the corresponding first subset of the set of feature scores, a time of day, a day of week, and a social activity;
calculating a set of feature weights corresponding to the plurality of sets of features based on a logistic regression model;
calculating a threshold value based on the set of feature threshold values and the set of feature weights;
receiving a third plurality of user IDs associated with a second event, wherein the third plurality of user IDs corresponds to a third plurality of users, and wherein the second event includes a sharing activity performed by the third plurality of users;
calculating a set of model scores corresponding to the third plurality of user IDs based on the plurality of sets of features, the set of feature threshold values, and the set of feature weights;
comparing each model score of the set of model scores with the threshold value; and
generating a fourth plurality of user IDs by combining a first set of the third plurality of user IDs with the second plurality of user IDs when each model score of a first subset of the set of model scores is at least one of greater than and equal to the threshold value, wherein the first subset of the set of model scores corresponds to the first set of the third plurality of user IDs, thereby expanding the audience segment corresponding to the second plurality of user identifications.

20. The computer program product of claim 19, wherein the first and second events further comprise at least one of a page-view activity and a landing on page activity.

21. The computer program product of claim 19, wherein the plurality of sets of features includes at least one of a user segment, a demographic, and a page-view category.

22. The computer program product of claim 19, wherein a user profile of the set of user profiles includes a user ID of the second plurality of user IDs and the corresponding set of features of the plurality of sets of features.

23. The computer program product of claim 22, wherein the first subset of the set of feature scores represents an occurrence of the user profile of the set of user profiles associated with the first subset of the set of features.

24. The computer program product of claim 19, wherein the logistic regression model uses a click log to calculate the set of feature weights.

25. The computer program product of claim 19, wherein the calculating a first model score of the set of model scores includes:
multiplying a first feature weight of the set of feature weights with the corresponding first subset of the set of feature scores to obtain a first value;
multiplying a second feature weight of the set of feature weights with the corresponding second subset of the set of feature scores to obtain a second value; and
adding the first and second values to obtain the first model score.

26. The computer program product of claim 25, wherein the calculating the threshold value includes:
multiplying the first feature weight with a first feature threshold value of the set of feature threshold values to obtain a third value;
multiplying the second feature weight with a second feature threshold value of the set of feature threshold values to obtain a fourth value; and
adding the third and fourth values to obtain the threshold value.
